(19) United States
(12) Patent Application Publication
(10) Pub. No.: US 2006/0216394 A1
(43) Pub. Date: Sep. 28, 2006

(54) Method and compositions to decrease serum cholesterol levels

(76) Inventors: Joshua Reid, Minnetonka, MN (US); Alison L. Eldridge, Edina, MN (US); Eric T. Gugger, Rogers, MN (US); Douglas J. Novak, Big Lake, MN (US); Daniel J. Lewandowski, Bloomington, MN (US)

Correspondence Address: GENERAL MILLS, INC., P.O. BOX 1113, MINNEAPOLIS, MN, 55440, US

(21) Appl. No.: 11/371,546

(22) Filed: Mar. 9, 2006

Related U.S. Application Data
(63) Continuation-in-part of application No. 10/207,601, filed on Jul. 29, 2002.
(60) Provisional application No. 60/660,016, filed on Mar. 9, 2005.
(60) Provisional application No. 60/750,459, filed on Dec. 15, 2005.

(51) Int. Cl. A23L 1/00

(52) U.S. Cl. 426/618

(57) ABSTRACT

Methods for the reduction of serum cholesterol levels in a mammal involve the consumption of a grain product having an enhanced soluble fiber content due to hydrolysis of insoluble dietary fibers in the grain product. Desirable approaches for the hydrolysis of grain products are described that result in an increase in the soluble fiber content. Some approaches for grain fiber hydrolysis result in a product with low levels of lysinoalanine. The grain products generally have high fiber grain brans, such as wheat bran. The grains products can be consumed as breakfast cereals. Similarly, flours including the hydrolyzed grain products can be incorporated into baked goods and the like.

### CROSS-REFERENCES TO RELATED APPLICATIONS

This application is related to copending U.S. patent application Ser. No. 10/207,601 to Dreese et al. filed on Jul. 29, 2002, entitled “Methods And Ingredient For Increasing Soluble Fiber Content To Enhance Bile Acid Binding, Increase Viscosity, And Increase Hypocholesterolemic Properties,” to U.S. Provisional Patent Application 60/660,016 filed on Mar. 9, 2005, entitled “High Soluble Fiber Compositions For Cholesterol Reduction,” and to U.S. Provisional Patent Application 60/750,459 filed on Dec. 15, 2005, entitled “Method and Compositions to Decrease Serum Cholesterol Levels” each of which are incorporated herein by reference.

### FIELD OF THE INVENTION

The present invention relates to approaches for the reduction of serum cholesterol through the consumption of grain products that have been hydrolyzed under controlled conditions to increase the soluble fiber content. The invention further relates to corresponding food products for inducing reduced serum cholesterol levels following consumption as well as food products with improved bile acid binding.

### BACKGROUND OF THE INVENTION

There is a large amount of information in circulation today concerning elevated cholesterol levels and the health consequences due to that condition. In an effort to combat this result, a number of pharmaceutical applications, dietary supplements and other solutions relating to the treatment of high cholesterol levels have been previously introduced. However, regrettably, many of these products have unpleasant attributes, such as mouth feel, that is they can feel slimy or sticky, have a displeasing taste or result in undesirable side effects which diminishes their overall value to the intended end user.

In addition, there also appears to be a growing disdain against ingesting some sort of dietary supplement, pharmaceutical treatment or other product to attain some perceived beneficial effect from such products. This may be due to a growing reliance on pills or tablets to sustain or maintain our health. The growing dependence on supplements may also surprisingly contribute to malnutrition as other valuable vitamins and minerals can be omitted or overlooked when too much focus is diverted to certain items. Moreover, certain supplements may actually remove valuable macronutrients and micronutrients from the system. Individuals may also be concerned with potential risks and side effects associated with certain medications, treatments or supplements. In fact, dietary restrictions and other health concerns may preclude certain portions of the population from even consuming such products. As such, there remains a continuing interest in developing good tasting, well balanced, food products that contribute to a well balanced diet as well as provide a vehicle by which to deliver the benefit of cholesterol reduction in a palatable and efficient manner to meet the changing needs of the population.

Cholesterol in humans is known to come from primarily two sources, the body's own production of cholesterol (endogenous) and dietary cholesterol (exogenous). Lipoproteins contain specific proteins and varying amounts of cholesterol, triglycerides and phospholipids.

Bile acids are synthesized from cholesterol in the liver and then secreted into the intestines. Reducing the level of bile acid reabsorption facilitates the maintenance of a healthy cholesterol level. One method for reducing bile acid reabsorption is achieved by increasing the gut viscosity. Alternatively, a non-digestible dietary component which binds bile acids secreted in the proximal jejunum will reduce bile acid reabsorption in the lower intestines (distal ileum).

There are three major classes of lipoproteins and they include very low-density lipoproteins (“VLDL”), low-density lipoproteins (“LDL”) and high density lipoproteins (“HDL”). The LDLs are believed to carry about 60-70% of the serum cholesterol present in an average adult. The HDLs carry around 20-30% of serum cholesterol with the VLDL having around 1-10% of the cholesterol in the serum. To calculate the level of non-HDL cholesterol present (find the level of LDL or VLDL levels), which indicates risk; the HDL is subtracted from the total cholesterol value.

Typically, the average person consumes between 350-400 milligrams of cholesterol daily, while the recommended intake is around 300 milligrams. Increased dietary cholesterol consumption, especially in conjunction with a diet high in saturated fat intake, can result in elevated serum cholesterol. Having an elevated serum cholesterol level is a well-established risk factor for heart disease and therefore there is a need to mitigate the undesired effects of cholesterol accumulation. High cholesterol levels are generally considered to be those total cholesterol levels at 200 milligrams and above or LDL cholesterol levels at 130 milligrams and above. By lowering the total system LDL cholesterol level, it is believed that certain health risks, such as coronary disease and possibly some cancers, that are typically associated with high cholesterol levels, can be reduced by not an insignificant amount.

Numerous studies relating to modifying the intestinal metabolism of lipids have been done to illustrate that such effects can reduce a high cholesterol level. Hampering the absorption of triglycerides, cholesterol or bile acids or a combination of these items results in a lowering of cholesterol levels in the serum.

Soluble fiber typically remains undigested, except by colonic microflora present in the lower intestines. Soluble dietary fiber is believed to have a beneficial effect in the reduction of high serum cholesterol levels and reducing the risk associated with such elevated levels. In addition, soluble dietary fiber can have the additional beneficial effect of reduced constipation and improved regularity. However, too much fiber in the diet can create undesirable gastrointestinal side effects such as flatulence, diarrhea, and abdominal cramps, etc. leading consumers to stay away from food products that contain too much dietary fiber, regardless of any associated health benefits. While some consumers may not completely avoid such products, they also do not typically regularly use such products due to the problems enumerated above or alternatively, or in combination due to the unpleasant taste of such products. This illustrates some of the problems with prior solutions that were aimed at providing high fiber diets directed at lowering cholesterol levels, and highlights the need to create a more balanced solution that fits not only within more normal dietary patterns but also meets consumer demand for better tasting, healthy products.

Another difficulty with many of the prior art solutions, regardless of whether they are successful in lowering cholesterol levels or not, is simply a matter of the cost of the ingredients or components which are needed to achieve the desired benefit. Only a very small segment of the population may be willing to pay eight or even ten dollars for a box of cereal or a loaf of bread, despite the benefit associated with it. In addition even if consumers purchase such a product initially, the high cost is likely to be more of a disincentive to purchase the product in the future, when compared with the incentive of the health benefit associated with the product.

A still further issue associated with such prior art food problems is that the consumer may be forced to eat several servings of the food product in order to attain the benefit of cholesterol reduction. This further complicates the delivery of the health benefit to the consumer in that a consumer may not want to eat a half a loaf of bread or consume three or more bowls of cereal at a meal. Moreover, over consumption can lead to other problems such as weight gain.

There have been previous attempts to increase the level of soluble fiber from sources that are high in insoluble fiber, however such prior methods have relied heavily on hydrating the resultant materials such that the material has a moisture content of around 95% and a solid content of approximately 5%. However, this creates a sticky or slimy mass that has a tendency to gel and is very difficult to handle. In addition, such prior processes generally extract only about 30 percent by weight of useable components from the initial starting source, and even a significantly lower amount of soluble fiber (usually less than four or five percent) creating a lot of waste through loss of solids and expense in evaporating water.

Another concern created by the extraction of fiber via such known methods is that the prior art processes create a lot of waste material in discarding the hulls and other portions of the crops. In addition, potentially less expensive sources of fiber are overlooked due to the fact that there is such a low level of soluble fiber present in such sources.

As such, what is needed is a process for increasing the recovery of soluble fiber from known sources or sources which do not economically prejudice the resulting food intermediate or food product and using the recovered fiber in the provision of food products that provide beneficial hypocholesterolemic activity.

### SUMMARY OF THE INVENTION

The present invention will now be described by reference to the following embodiments, which are not intended to be limiting in scope.

The present invention relates to a method for modifying cereal or grain based materials that have low soluble fiber content and high insoluble fiber content so as to enhance bile acid binding capacity by increasing the level of available soluble fiber that can be obtained from such starting materials as well as the viscosity in order to create ingredients that are useable in food intermediates that are suitable for lowering unhealthy cholesterol levels. More particularly, the present invention relates to a process for controlling a number of parameters such as temperature and moisture content as well as providing for such other steps as the mechanical pretreatment and alkali treatment of grain or cereal based starting materials, including but not limited to wheat bran or shorts.

The present invention is related to a novel component for use in a food intermediate intended for incorporation into a consumer food product. More specifically, the ingredient or component, provided either alone or acting synergistically with other select ingredients is part of an ingestible food product intended for human or animal consumption that provides a health benefit. The food component provides beneficial hypocholesterolemic activity through increased bile acid binding activity and increased viscosity while simultaneously delivering a food product, which is not adversely affected by the inclusion of the modified bran product, either in taste or texture or in any undesirable side effects.

In one embodiment of the present invention, a method of increasing soluble fiber levels and viscosity in grain or cereal based components that are suitable for use in food intermediates is described and comprises the steps of, initially providing a source of material having an initial extractable soluble fiber content of less than 4% by weight on a dry weight basis. Next, the material is hydrated to a moisture content of 40-60% and then an alkali is added to the material to create a mixture. The mixture may or may not be subjected under vacuum before further processing. The mixture is then cooked, such as through steaming under pressure. The moisture content of the material may be manipulated during such cooking. The mixture is then neutralized through the addition of an acid and then dried to less than 20% moisture content. Finally, the mixture is ground to form a powder having an extractable soluble fiber content of greater than 8% by weight and a ratio of soluble fiber to total dietary fiber of at least about 1:10.

In a further embodiment of the present invention, a cereal based material for use as an ingredient for use in preparing a food intermediate having improved bile acid binding capacity and viscosity is described and comprises, a first material having a particle size of greater than 10 microns. The first material has an initial level of extractable soluble fiber. An alkali selected from a group of calcium hydroxide, sodium hydroxide and potassium hydroxide, a hydrating agent and a neutralizing agent are mixed with the first material. The first material after addition of the alkali, hydrating agent and neutralizing agent creates a second material that has a second level of extractable soluble fiber. The second material level of extractable soluble fiber from the second material is at least 50% greater than the first level of extractable soluble fiber of the first material. In general, a grain product with improved bile acid binding has an increased soluble fiber content relative to an equivalent un-hydrolyzed grain product.

The powder obtained from the forgoing process or the material can be used as an ingredient in the preparation of food intermediates such as dough as well as in the preparation of ready to eat meals, ready to eat cereals, snacks and baking product such as breads, muffins, baking mixes and the like. Specifically, a breakfast cereal can comprise a grain composition with an increased soluble fiber content relative to an equivalent un-hydrolyzed grain product. Furthermore, the powder can be formulated into flours that can be distributed to consumers and/or commercial food preparation establishments.

In some aspects of the invention, the invention pertains to a method for the reduction of serum cholesterol in a mammal, such as a human. The method comprises consuming a grain product having an enhanced soluble fiber content due to hydrolysis of insoluble fibers in the grain. The hydrolysis approaches described herein are suitable for the formation of the grain products with enhanced soluble fiber content.

This and other objects of the invention will become clear from an inspection of the detailed description of the invention and from the appended claims.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Throughout the specification and claims, percentages are by weight and temperature in degrees Centigrade unless otherwise indicated. Each of the referenced patents and patent applications are incorporated herein by reference.

The soluble fiber component of the present invention can be derived from a wide variety of grains, cereals or components thereof and are composed of polysaccharides having a variety of structures. Examples of such grains or cereals include wheat, rice, corn, oats, barley and the like. As indicated above, soluble fiber is generally resistant to human digestive enzymes, except for colonic microflora present in the lower intestines, and is known for its water and ion-binding capacity. Obtaining an enhanced level of soluble fiber is an aim of the present invention.

Handling of viscous soluble fibers is normally difficult due to the fact that the fiber has high viscosity. Surprisingly, applicants have discovered that by performing the modification as described herein where the solids content of the bran ranges from between 40 to 60% by weight and more preferably between 45% to 55% by weight, significant improvement in the conversion to soluble fiber can be obtained over prior art solutions. If the moisture content falls outside of this narrow window, applicant's have found that the material is either too sticky or slimy due to high water content or in the alternative there isn't sufficient moisture in the product which creates other handling difficulties. Following are exemplary sources of soluble fiber material.

Psyllium, is a known mucilaginous material derived from seeds from the plants of the Plantago genus, Plantago ovata, found in sub-tropical areas. The seeds are dark and shiny and have something of a concave shape to the exterior. Psyllium has been regularly used as a laxative to promote regular bowel function. Psyllium seed may be used in ground, dehusked or in whole form and represents a source of soluble dietary fiber. However, psyllium can have a coarse or rough texture making ingestion occasionally difficult, if the fiber component is not processed in a manner making it readily useable in a consumer food product.

Oat flour is essentially heat-treated oat groats (hulled, crushed oats) or rolled oats that are ground on a hammer mill or other machine. There is no separation of the components during the processing of the flour.

Oat bran is produced by grinding clean oat groats or rolled oats and separating the resulting flour by suitable means, such as sieving, into fractions such that the oat bran fraction is not more then 50% of the original starting material.

Wheat bran is produced by grinding or milling clean wheat and then separating the resulting flour by suitable means, such as sieving, into fractions. Regular wheat bran has only about 2.5% soluble fibers. Wheat bran is relatively inexpensive and generally less than about $0.02/per pound.

Barley, is processed in a manner that resembles the procedure as set forth above, in that it consists of cleaning, hulling, sieving and then grinding. Waxy hulless barley has a higher dietary fiber content than most other sources of fiber and can range from 14 to 20% of the dry weight.

Wheat shorts, as used herein, refers to a product or grain that cannot be cleanly separated into bran, germ or endosperm. Wheat shorts are made up of a substantial portion of wheat bran and contain about 40% fiber of which more than half is arabinoxylan. Wheat shorts are available in large quantities and roughly at about $0.02/pound. Wheat shorts as used in the present invention are available from General Mills, Inc. Minneapolis, Minn. Wheat shorts are often by-products of the milling industry.

The starting material of the present invention are generally selected from the group of milling by-products or other grains or components thereof which do not create an economic burden or disincentive to their inclusion into the food intermediate or food product being produced in accordance with the present invention. In one embodiment of the present invention, wheat bran is selected for illustration in the following example. It should however be understood that oat bran, rice bran and corn bran may be used in connection with the present invention. In addition, the starting material may also comprise a mixture of two or more of wheat bran, oat bran, corn bran or rice bran.

The soluble fiber content of regular wheat bran is approximately 2.2% on a dry weight basis. Wheat shorts, oat hulls, corn cobs and other sources having high levels of insoluble fiber material may also be used instead of wheat bran as a starting material.

It has been found that through the treatment of wheat bran with enzymes (cellulases and xylanases) the soluble fiber content can be increased by about 100% to approximately 4.4% on a dry weight basis. However, more significant improvement in increasing the soluble fiber content can be obtained by treatment with alkali, steaming (in the presence or absence of a vacuum) and grinding the material into a very fine powder. While 15% soluble fiber on a dry weight basis has been achieved on a number of occasions, greater than 8% and 10% are usual and more particularly 11% soluble fiber content is the more typical amount obtained from the starting material. In addition, achieving levels of 15% or more through the process described herein can yield a soluble fiber that has a bitter flavor or is discolored and which may not be suitable in as broad a range of applications as other levels of ingredients.

It has been surprisingly discovered, that by increasing the soluble fiber content of the starting material through the process described in the present invention a reduction of up to 25% of the cholesterol level of hamsters can be obtained through use of the modified bran obtained by the process of the present invention over untreated or unmodified bran.

In one embodiment of the present invention, the wheat bran is modified by treatment with heat (steaming), water and alkali. The amount of water suitable for use in the present invention ranges from approximately 20% to in excess of 2500% of the weight of the bran. Generally, however, it is preferred to use an amount of water that is equal to or less than the dry weight of the bran, or 30 to 100% of the dry weight basis of the bran.

Calcium hydroxide (CaOH), due to its additional nutritional value (increasing calcium level) and cost, is the preferred alkali, however other hydroxides are also suitable for use in the present invention, including but not limited to sodium hydroxide (NaOH) and potassium hydroxide (KOH). In practicing the present invention the amount of calcium hydroxide ranges from roughly 1% to 10%, with the preferred amount being approximately 3-8% and more preferably about 4-8% dry weight of the bran. After the addition of the alkali, additional water may be added to maintain the moisture level to between 40% to 60% and more preferably to between 45% to 55%.

In one working example for the present invention, the dry ingredients, wheat bran (approximately 90-98% on a dry weight basis in this example is 10 pounds) and calcium hydroxide (2-10% on a dry weight basis and approximately 0.8 pounds for this exemplary process) are mixed together are then added into the cooker. The cooker has an initial shell temperature of around 70-75° F.

The wheat bran is then steamed/cooked at atmospheric pressure or alternatively, cooked in a pressurized vessel. In the present embodiment, the heating/steaming is done for a total time range of between 10 to 120 minutes with approximately 40 to 60 minutes being preferred. For the present example, the heating/steaming is done in three stages or durations of 10 minutes, 10 minutes and 20 minutes. During the heating/steaming, the pressure in the vessel is maintained at around 25 to 36-psig. The cooking/steaming temperature ranges from between 100° C. to 140° C. and more preferably from about 130° C. to 138° C., and the heating/steaming is done in a batch cooker designed and used in the production of ready to eat (“RTE”) cereals. The contents are then discharged from the cooker. The batch after removal from the cooker had a moisture content of approximately 46%.

After the cooking step (the heating/steaming), the ingredients are mixed in a Hobart mixer. Citric acid is then added to neutralize the bran during the mixing Hydrochloric acid may also be used. In the present embodiment approximately 0.82 grams of citric acid is used for roughly each gram of alkali (calcium hydroxide) that was added. The cooked neutralized bran is then dried for twenty minutes at a temperature of 200°-210° F. to obtain a moisture content of less than 20% and preferably to about 12% by moisture. The dried bran is then allowed to equilibrate overnight and is then ground to a powder with a mill.

To maintain an adequate moisture level for the present invention, the ratio of bran to water to alkali (calcium hydroxide) as provided in the present example is approximately 1 to 0.3-0.5 to 0.03-0.05 and more preferably 1 to 0.34 to 0.04. Additional water enters the cook via the condensation of the steam that is injected into the batch cooker.

The powder that is obtained by the present example can then be used with or incorporated as an ingredient in a food intermediate. The term food “intermediate” as used herein refers to at least one intermediate that undergoes a further processing step, such as baking, mixing, etc. before the final food product is formed. In food processing, one or more intermediates may be formed. An example of a food intermediate is dough which can be used in the formation of breads, cereals, pasta, muffins, rolls and the like.

In addition to the foregoing processes, in order to control or reduce bitter flavors produced by the process, oxidation may be reduced (through the addition of ozone), the bran may be sheared during cooking or the concentration of the alkali may be changed. If the bran subsequent to treatment is too dark then the color of the bran may be bleached through the use of hydrogen peroxide. The hydrogen peroxide is believed not to have any effect on the flavor of the product.

In addition to the steps referenced in the foregoing example, fine grinding of wheat shorts or wheat bran may also be done (e.g. by using a Nisshin Engineering Blade Mill or DPM mill) prior to the start of the process. The wheat bran is ground to a particle size of greater than 10 microns and preferably about 16 microns. Another mechanism for performing the initial separation step of the present invention is through use of a Turborotor. The grinding may or may not be performed prior to the hydrating the material.

In alternative embodiments, the bran can be processed using extrusion cooking or vacuum cooking. It has been found that these processes may improve the color of the mixture as well as allow for higher calcium hydroxide levels. Extrusion cooking may also aid in lowering costs associated with the process and further increasing the soluble fiber content of the mixture. When extrusion cooking is used, the optimal moisture content is around 30-40% or more preferably about 32% as opposed to roughly the 45-55% range, which may be needed in the batch cooker.

In a further example of the present invention, the dry ingredients (wheat bran 90-95% and calcium hydroxide 5-10%) are mixed together and then added into a cooker having a shell temperature of 70-75° F. An oxygen scavenger ingredient such as sodium bisulfite, at 0.01 to 0.10% level, may or may not be added in the mixture. The ingredients are rolled and subjected to a vacuum of −25 psig for five minutes. The ingredients are cooked for 30 minutes at a pressure of 35 psig.

After the cooking/steaming, vacuum is pulled for five minutes. After this initial period, a vacuum is pulled for an additional two minutes and cold water spray is added. The cooker is then opened and the contents discharged.

The contents are then mixed in a Hobart mixer and the bran is neutralized through the addition of citric acid while the solution is being mixed. After mixing, the bran is dried for 20 minutes for between 200-210° F.,—milled by use of a Fitz mill and then dried for another 10 minutes. Once the mixture equilibrates overnight, the mixture is then ground further with a pin or disc mill.

In using the above process, the bran appeared lighter in color than in the first described process, presumably due to the reduction of Maillard browning reactions and other oxidation processes.

In vitro tests were conducted to determine the level of bile acid binding in connection with a wheat bran that had been modified in accordance with the present invention and an unmodified wheat bran. The following results were obtained and are shown in the table below.

TABLE 1

| | Bile | Vicosity | |
|---|---|---|---|
| | Acid Binding (% | at 37° C., cP* | Soluble |
| Component | of Cholestyramine) | g/cm³ | Fiber, % |
| Unmodified | 6.4% | 2.03 | 2.7 |
| White Wheat Bran | | | |
| Ca(OH)₂ modified | 10.5% | 8.61 | 10.2 |
| White Wheat Bran | | | |

As table 1 illustrates, the process of the present invention improved the bile acid binding capability of the wheat bran by approximately 70% due to the increase in the level of soluble fiber and/or viscosity.

An exemplary food was prepared consisting of a ready to eat (RTE) cereals. This exemplary RTE cereal is in the form of flakes that are created by preparing a cooked cereal dough through known methods and then forming the cooked cereal dough into pellets that have a desired moisture content. The pellets are then formed into wet flakes by passing the pellets through chilled roller and then subsequently toasting or heating the wet cereal flakes. The toasting causes a final drying of the wet flakes, resulting in slightly expanded and crisp RTE cereal flakes. The flakes are then screened for size uniformity. The final flake cereal attributes of appearance, flavor, texture, inter alia, are all affected by the selection and practice of the steps employed in their methods of preparation. For example, to provide flake cereals having a desired appearance feature of grain bits appearing on the flakes, one approach is to topically apply the grain bits onto the surface of the flake as part of a coating that is applied after toasting.

The following table represents the RTE flake cereal prepared in accordance with the present example in which approximately 30% of the wheat used in the flake cereal has been replaced with the modified bran of the present invention.

TABLE 2

| | | | Modified Bran Flake | |
|---|---|---|---|---|
| Description | Standard Flake Cereal | | Cereal | |
| Total Fiber | 3.0 | g | 5.0 | g |
| (g/serving) | | | | |
| Soluble Fiber | 0.41 | g | 1.09 | g |
| (g/serving) | | | | |
| Calcium | 0 | mg/serving | 14.4 | mg/serving |
| (w/out fortification) | | | | |

The analysis provided in table 2 above, illustrates the increased level of soluble fiber in the RTE cereal by using the modified bran of the present invention in lieu of wheat bran obtained from conventional sources.

While the foregoing example is directed to the manufacture of flake cereals, it is readily apparent, that the manufacturing method can be modified to produce puffed or extruded cereals as well in which the dough after forming is either fed through an extruder to create the desired shape or, in the alternative, is forced through a die or other orifice to generate puffed cereals.

In another method of the present invention, wheat shorts were obtained and the process as described above was followed except that the wheat shorts were treated with sodium hydroxide at a pH of 12.1 for one hour. The wheat shorts were then neutralized with hydrochloric acid to a pH of approximately 6.8.

The wheat shorts used in the alternative embodiment after undergoing treatment according to the present invention showed a soluble fiber content of approximately 24% on a dry weight basis. The extract was obtained through centrifugation or sedimentation by known methods.

The invention should not be limited to wheat bran or wheat shorts in achieving higher soluble fiber levels. Instead, the process described in the present invention is suitable for use with any similar carbohydrate/fiber backbone such as those in corn, wheat, barley, oats, rice and portions thereof. For example, where oat hulls are used as the starting material and subjected to the same process the amount of soluble fiber contained in the extract on a dry weight basis was 16%, which represents a significant improvement over the soluble fiber content of oat hulls, which normally is in the low single digits on a dry weight basis. Corn bran, oat bran and rice bran have also been found to be suitable starting materials. In another embodiment, mixtures of two or more materials selected from the group of wheat bran, rice bran, oat bran and corn bran may be used.

It will thus be seen according to the present invention that a highly advantageous method for converting insoluble wheat fiber to soluble fiber has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The accepted definition of dietary fiber is essentially unchanged since at least the 1970's. The accepted scientific definition includes, cellulose, hemicellulose, lignin, gums, modified celluloses, mucilages, oligosaccharides, pectins, and associated minor substances, such as waxes, cutin and suberin. The official methodologies for evaluation of these compositions is monitored by the American Association of Cereal Chemists (AACC). An AACC report on a recent committee evaluation is found in an article entitled “The Definition of Dietary Fiber,” Cereal Food World, Vol. 46, No. 3, pp 112-126 (March 2001), incorporated herein by reference.

In addition to tracking accepted definitions of dietary fiber, the AACC also provides official and approved protocols for the evaluation of the dietary fiber content of food products. Corresponding to the AACC methods, there are international official methods sanctioned by AOAC International. As used herein and consistent with accepted approaches in the field, fiber levels were evaluated using AOAC 991.43 Total, Soluble, and Insoluble Dietary Fiber in Foods—Enzymatic-Gravimetric Method, MES-Tris Buffer. The equivalent AACC method is AACC 32-07. A general principle behind the methods is the determination of the edible parts that are not subject to degradation. As such, the samples are defatted and heated to gelatinize the starch. Then, samples are subjected to protease, amylase and amyloglucosidase (glucoamylase) to break down the digestible components of the food. The residues after the removal of the digestable components are quantified and adjusted for protein and ash to adjust for any contributions from the enzymes themselves. As a control, the enzymes are checked for purity through an examination that they do not digest dietary fiber.

Applicants incorporate herein by reference the full disclosure in AOAC 991.43, including but not limited to the complete procedure for fiber quantification. In this method, MES-Tris buffer replaces a phosphate buffer in older methods. Duplicate 1-gram dried food samples are subjected to sequential enzymatic digestions with heat-stable alpha-amylase followed by protease and then amyloglucosidase. Insoluble dietary fiber is filtered, and the residue is washed with warm distilled water. A solution with the filtrate and water washings is precipitated with 95% ethanol to determine the soluble fiber content. The precipitate is then filtered and dried for the determination of the insoluble fiber content. The insoluble fiber and soluble fiber values are corrected to protein and ash to obtain final values. The methodology is described further also in the book Dietary Fiber Analysis and Applications, by Cho et al., (AOAC International, 1997), incorporated herein by reference.

Improved hydrolysis embodiments involve the application of high shear, which results in decreased or eliminated undesirable protein hydrolysis by-products. The improved methods for increasing soluble fiber content comprise the heating of a mixture of the grain product, a base/alkali and water under pressure to effectuate the fiber hydrolysis. The pressure, temperature and heating time can be adjusted to yield the desired degree of hydrolysis. In general, the method is conducted at a temperature above 100° C. for a time of at least about 10 minutes. In embodiments of particular interest, the mixture of grain product, base and water is mixed at high shear to form a highly uniform mixture. Additional details of an appropriate method are described below. In one approach to apply high shear, the mixture passes through an extruder in a continuous process. The use of an extruder provides advantages with respect to the efficiencies associated with a continuous process. The amount of water and base can be appropriately controlled to produce a hydrolysis product with desired properties.

In some embodiments, the hydrolysis product with increased soluble fiber content has levels of protein hydrolysis products below selected thresholds. In particular, lysinoalanine (LAL) moieties are desired to be below particular levels since high levels have been associated with health concerns. Protein hydrolysis under some conditions has been observed to yield increases in both free lysinoalanine, i.e., the dipeptide, as well as total lysinoalanine, which includes lysinoalanine dipeptides within protein structures. The use of high shear in the hydrolysis method has been discovered to reduce LAL levels in the resulting high soluble fiber product. While not wanting to be limited by theory, this improved result may result from reduction or elimination of regions with high base concentrations, i.e., particularly high pH, prone to undesirable protein hydrolysis, as a result of the more uniform mixture of the base under high shear within the hydrolysis mixture. If desired, it has been found that addition of L-cysteine amino acids can reduce total LAL levels at the expense of increased free LAL levels.

In general, a hydrolysis mixture is formed comprising a fiber-based food product, such as wheat bran, water and base/alkali. Suitable fiber-based food products for processing using the methods described herein were described in detail in the previous section. The hydrolysis mixture is heated to modify the hydrolysis mixture, in particular to hydrolyze some of the insoluble fiber to form an increased amount of soluble fiber. The amount of water suitable for use in the present invention ranges from about 20% to in excess of about 2500% as a percent of the weight of the fiber-based solids. Generally, however, it is desirable to use an amount of water that is equal to or less than the dry weight of the fiber-based solids, or in some embodiment from about 20% to about 100% of the dry weight of the fiber-based solids, in other embodiments from about 25% to about 80%, in additional embodiments from about 30% to about 60% and in further embodiments from about 30% to about 50% of the dry weight of the fiber-based solids. A person of ordinary skill in the art will recognize that additional ranges within the explicit ranges above of water content are contemplated and are within the present disclosure. Controlling the moisture content to within the ranges herein can be important to obtaining the benefit of increasing the soluble fiber while reducing or eliminating the levels of free LAL.

In improved embodiments, high shear is added to the hydration mixture prior to and/or during cooking. If high shear is added during cooking, the high shear can be applied for all or a selected portion of the cooking time. High shear can be applied with a high shear mixer and/or with an extruder. Surprisingly and significantly improved results are observed when the hydrolysis mixtures are subjected to high shear. Specifically, the results of the method are more uniform and reproducible. In addition, the production of undesirable protein hydrolysis by-products, in particular lysinoalanine levels, is very significantly reduced or eliminated through the application of shear in combination with control of the moisture content to between 20% and 60%, as discussed further below. While not wanted to be limited by theory, a possible explanation for the dramatically improved results is that the base is more evenly distributed through the material such that the hydrolysis reaction takes place at a correspondingly more uniform pH such that extremely high pH, i.e., strongly basic, regions within the mixture are reduced or eliminated that have the capability of hydrolyzing the protein.

The amount of shear is generally correlated with the operating conditions of the apparatus used to apply the shear. Specifically, in a high shear mixer, the mixer can be operated with at least about 50 revolutions per minute (rpm) or the equivalent, in further embodiments from about 100 rpm to about 10,000 rpm and in additional embodiments from about 200 rpm to about 5,000 rpm. Suitable high shear mixers for food products are commercially available. For example, high shear mixers include, for example, IKA Ultra Turrax T50 high shear mixer (IKA Works, Inc., Wilmington, N.C.) and Silverson High Shear Food Mixers (Silverson Machines Ltd., U.K.). The ranges of specific mechanical energy provided below in the context of extrusion can also provide guidance with respect to the high shear mixing since delivery of similar amounts of mechanical energy with a mixer should provide similar results as with delivery with an extruder. In general, the high shear mixing is performed for at least about 1 minute, in further embodiments for at least about 2 minutes, in other embodiments from about 3 minutes to about 30 minutes. A person or ordinary skill in the art will recognize that additional ranges of rpm and mixing times within the explicit ranges above are contemplated and are within the present disclosure.

A potentially undesirable protein hydrolysis by-product is lysinoalanine. Total lysinoalanine (LAL) levels refers to the detected amounts of lysinoalanine peptide combinations identified within a protein structure, while free LAL levels refers to lysinoalanine dipeptides free of a protein structure. Low LAL levels are advantageous due to potential concerns regarding LAL in foods as a possible relationship with renal toxicity. Although there are no limits on LAL levels in foods in the United States, Dutch law limits LAL levels in certain ingredients.

In some embodiments, total LAL concentrations in the modified fiber-based product are no more than about 500 parts per million (ppm), in further embodiments no more than about 450 ppm, in additional embodiments no more than about 425 ppm, and in other embodiments from about 400 ppm to about 100 ppm. Furthermore, free LAL levels, in some embodiments, are no more than about 5 ppm, in further embodiments no more than about 3 ppm, in other embodiments no more than about 2 ppm and in additional embodiments from about 1 ppm to 0.1 ppm. In some embodiments, the free LAL levels may be undetectable. A person of ordinary skill in the art will recognize that additional ranges of LAL concentrations within the explicit ranges above are contemplated and are within the present disclosure.

Amino acid analysis can be performed on Beckman Instruments Models 6300 or 7300 dedicated amino acid analyzers. These instruments incorporate 10 cm cation exchange columns, three sequential sodium-based eluents, and sodium hydroxide for column regeneration. Absorbance is measured at 440 and 570 nm following post-column color development by ninhydrin reagent at 131° C. Data acquisition and management is accomplished with a computer running Beckman System Gold 8.10 chromatography software. Beckman reference solutions fulfill standardization requirements. (S)-2-Aminoethyl-1-cysteine (S2AEC) or glucosaminic acid is added to the samples as an internal standard. The Beckman amino acid analyzer can be employed to evaluate hydrolyzed amino acid content (protein bound LAL) or free amino acid content (unbound LAL). To determine the free LAL levels, a 2.0 g sample is extracted for 30 minutes with 20 mls of HPLC-grade water. The extraction solution is centrifuged, and the liquid is poured off. The liquid is then diluted 1:2 with the buffer/internal standard for use with the apparatus and filtered. The filtered liquid is then injected into amino acid analyzer.

To determine bound LAL, up to 1000 mg of sample is weighed into a 10 milliliter (ml) vacuole. A 400 microliter (μl) quantity of 1% phenol in water and 1000 μl of concentrated HCl are pipetted into the vacuole. Then, the vacuole is sealed with a torch. The sealed sample is digested in an oven for 21 hours at about 115° C. After digestion is complete, the vacuoles are cooled to room temperature. The cooled samples are vortexed to homogenize the slurry. The homogenized slurry is transferred to an appropriate sized volumetric flask using a Pasteur pipette. Sufficient Beckman “Na—S” buffer solution is added to make a 10 ml volume. The diluted solution is analyzed in a standard manner with the Beckman Amino Acid Analyzer.

The improved method of performing the hydrolysis of grains to increase the soluble fiber content and reduce the LDL levels is described further in copending U.S. Provisional Patent Application 60/686,674 filed on Jun. 2, 2005 to Reid et al., entitled “Grain Product With Increased Soluble Fiber Content And Associated Methods.”

As described herein, consumption of the modified/hydrolized grain products described herein can be effective to reduce serum cholesterol levels by a significant amount. Serum cholesterol reductions can be effective in mammals including, for example, humans, farm animals and pets, such as dogs, cats, hamsters, and rabbits. Consumption of the modified grain products can be accomplished through the incorporation of the high soluble fiber products into general foodstuffs of the individual's diet.

In general, the modified grain products are incorporated into food products that make up components of acceptable diets for most individuals. For example, the modified grain brans can be combined with other flours to form fiber-fortified flours. The fiber fortified flours can be incorporated into baked goods, such as, breads, muffins, cakes, and the like. Selection of the amount of modified grain products incorporated into particular baked goods can involve a balance of factors including, for example, taste, texture, desired amounts of soluble fiber ingestion and other features of an individual's diet.

In some embodiments of particular interest, the modified grain brans can be incorporated into a breakfast cereal, which can be ready to eat cereals or cooked cereals. Breakfast cereals have become an accepted form of food product with significant amounts of grain fibers. If the breakfast cereals incorporate modified grain products as described herein, the breakfast cereals can be designed with greater flexibility with respect to taste, texture and other features desirable to consumers while providing to the consumer high levels of soluble fibers that provide significant health benefits. Furthermore, beneficial health benefits resulting from high soluble fiber consumption can be provided at reduced costs to the consumer since the modified grain products herein can be produced from very low cost ingredients while yielding very high levels of desirable soluble fibers. The breakfast cereals generally can be provided in a range of desirable forms, such as flakes, nuggets, O's and the like.

With respect to consumption of the modified grain products described herein, based on a 2600 Calorie diet, an individual diet generally can be designed for the consumption of from 20 grams/day (g/d) to about 150 g/d and in further embodiments from about 40 g/d to about 120 g/d. Similarly, a beneficial diet incorporating modified grain products herein can be based on the consumption of soluble fiber of 3 g/d to about 15 g/d and in further embodiments from about 5 g/d to about 12 g/d. These values can be scaled linearly for diets with a different value of total Calories. Calories refer to dietary Calories, which are equal to kcals or 1000 scientific calorie units. A person of ordinary skill in the art will recognize that additional ranges of modified grain bran consumption and soluble fiber consumption within the explicit ranges above are contemplated and are within the present disclosure.

Diets based on suitable consumption of soluble fibers from modified grain products can result in statistically significant reductions in serum cholesterol levels. Specifically, consumption of diets with appropriate amounts of modified grain products can result in reductions of total cholesterol levels of about 2.0 to about 20.0 milligrams/deciliter (mg/dl), in further embodiments from about 4.0 to about 15.0 mg/dl and in additional embodiments from about 5.0 to about 10.0 mg/dl. Similarly, with an appropriate diet based on modified grain products described herein, LDL-C levels can be reduced of about 2.0 to about 15.0 mg/dl and in further embodiments from about 4.0 to about 10.0 mg/dl. A person of ordinary skill in the art will recognize that additional ranges of cholesterol reduction within the above ranges are contemplated and are within the present disclosure.

### EXAMPLES

### Example 1

### Animal Study of Serum Cholesterol

This example demonstrated the ability of modified wheat bran to lower the serum cholesterol levels of hamsters fed the modified wheat bran in their diet.

In a study using an independent laboratory, Ca(OH)₂ modified wheat bran, obtained from the process described herein, was used in connection with a control and other diets and was fed to laboratory animals. One hundred thirty (130) hamsters were initially fed the same diet for one week. The hamsters were then randomly selected and separated into groups of 10 and were fed the test diets identified in the following table for four weeks. Blood samples were drawn from each of the animal groups and readings taken at the 3 and 4-week intervals and averages obtained. The following table shows the average blood cholesterol level taken after 4 weeks from the laboratory animals identified above.

TABLE 3

| Group/Diet | Cholesterol Levels |
|---|---|
| Control Diet | 204 |
| Unmodified wheat bran | 192 |
| Alkali modified bran | 153 |
| Psyllium Diet | 145 |
| Oat Based Cereal Diet | 188 |

The study results obtained in Table 3 above reveals that through the use of the modified bran obtained in accordance with the present invention, the laboratory hamsters realized a 25% reduction in cholesterol levels. While the psyllium diet produced slightly better results, psyllium, as indicated above, suffers from other drawbacks.

### Example 2

### Bile Acid Binding

In conducting a comparison of the bile acid binding properties of the wheat shorts obtained by the above mentioned process, an arabinogalactan—a soluble fiber marketed under the name LAREX available from Larex, Inc. of St. Paul, Minn. LAREX, has been shown to reduce cholesterol levels but is an expensive ingredient. The following results show the amount of bile acid binding of a sample of material prepared in connection with the invention compared with Larex (micrograms of bile acid per milligram of sample):

| | Binding (% of |
|---|---|
| Sample | cholestyramine) |
| Wheat Shorts | 12.6 |
| LAREX | 7.5 |

The values are reported as the bile acid binding cpaability relative to the bile acid binding of the dietary fiber cholestramine, which is known to reduce serum cholesterol levels through bile acid binding. Thus, the values are the percent of bile acid binding relative to an equivalent weight of cholestyramine.

### Example 3

### Biomedical Research Study with Hydolyzed Wheat Bran

This example demonstrates the efficacy of the modified grains to demonstrably lower serum cholesterol levels in humans when on an suitable diet based on the high soluble fiber wheat bran.

Certain soluble fibers have cholesterol-lowering properties. This study's objective was to explore the cholesterol-lowering ability of a novel soluble fiber source, hydrolyzed wheat bran. Results were compared to a reference diet without added fiber and to oat bran, a known source of cholesterol-lowering soluble fiber. Twenty participants (10 males; 10 females), between 32-66 years of age with moderate hypercholesterolemia, were fed four diets differing in soluble fiber type: a reference average American diet (AAD, 35% TF, 14% SFA) and two test diets in which the AAD was supplemented with oat bran (OB) or hydrolyzed wheat bran (HWB). A third unrelated test diet was tested and is not reported here. All diets were prepared and provided for four weeks each in a randomized, crossover design. At 2600 kcals, the OB and HWB diets each provided 6.3 g of soluble fiber. The fibers were incorporated primarily into baked goods. Relative to the AAD, LDL-C was significantly (p<0.05) reduced by both OB (−10.0±2.8 mg/dL) and HWB (−10.4±2.9 mg/dL). Additionally, triglyceride and insulin levels were significantly reduced by OB but not by HWB. HDL-C, glucose and leptin levels were not different across diets. This study demonstrates that wheat bran modified to increase its soluble fiber content, is effective in lowering LDL-C.

Production of Modified Wheat Bran for Biomedical Research Study

Objective: Produce 200 pounds of modified wheat bran for use in a clinical trial.

Materials and Methods

The raw materials for this process are soft white wheat bran, calcium hydroxide (Mississippi Lime), and citric acid.

Process equipment includes Wing 12 batch cookers, Hobart mixer, and pin mill.

Batch Cooking Procedure:

1. Mix all the dry cooker ingredients.

2. Start w/cooker shell temperature at 70-75 F.

3. Charge the cooker with dry ingredients.

4. Roll and vacuum at −25″ Hg for 5 min.

5. Cook 30 min at 35 psig.

6. Close steam valve, open vacuum valve.

7. Pull vacuum without cold water spray for 5 min.

8. Pull vacuum with spray for additional 2 min.

9. Open cooker and discharge contents.

10. Mix cooked bran in a Hobart mixer.

11. Set aside a small sample of cooked bran for moisture content det.

12. Neutralize bran w/citric acid solution while mixing.

13. Dry for 20 min. at 200-210 F; Fitz mill; dry for another 10 min.

14. Let sample equilibrate overnight.

15. Grind with a pin mill.

TABLE 4
Batch Cooking Formula

| | | | |
|---|---|---|---|
| GMI Code | Mass, lbs | Mass, g | % |

Cooker Ingredients

| | | | | |
|---|---|---|---|---|
| 5271 | Wheat Bran | 10.0 | 4535.9 | 92.6 |
| | Water | 0.0 | 0.0 | 0.0 |
| | Ca(OH)2 | 0.8 | 362.9 | 7.4 |
| | Total | 10.8 | | 100.0 |

Neutralization Solution

| | | | |
|---|---|---|---|
| 1347 | Citric Acid | 0.656 | 297.6 |
| | Water | 0.656 | 297.6 |

The resulting dried flour was modified wheat bran. The procedure was repeated to produce the desired total quantity. A sample of the combined product was submitted to Medallion Laboratories for analytical testing. Table 5 summarizes the final material composition.

TABLE 5
Modified wheat bran composition

| Test Description | Results | Units |
|---|---|---|
| Amino Acid Profile | | |
| Aspartic Acid | 0.994 | % |
| Threonine | 0.242 | % |
| Serine | 0.185 | % |
| Glutamic Acid | 2.45 | % |
| Proline | 0.935 | % |
| Glycine | 0.928 | % |
| Alanine | 1.37 | % |
| Valine | 0.757 | % |
| Methoionine | 0.241 | % |
| Isoleucine | 0.388 | % |
| Leucine | 0.882 | % |
| Tyrosine | 0.465 | % |
| Phenylalanine | 0.543 | % |
| Histidine | 0.367 | % |
| Lysine | 0.356 | % |
| Arginine | 0.488 | % |
| Ammonia | 0.358 | % |
| Ash Analysis | 12.39 | % |
| Beta Glucan | 2.07 | % |
| Calcium | 3730 | mg/100 g |
| Calories (FBDG Subtracted) | 265 | Calories/100 g |
| Carbohydrates, Available | 44.6 | % |
| Carbohydrates, Total | 63.4 | % |
| Fatty Acid Analysis w/Profile | | |
| Total Fat | 4.66 | % |
| Saturated Fat | 0.75 | % |
| Monounsaturated Fat | 1.05 | % |
| cis-cis Polyunsaturated Fat | 2.65 | % |
| trans Fat | 0.01 | % |
| Fiber, Group | | |
| Total Dietary Fiber | 31.4 | % |
| Insoluble Fiber | 18.8 | % |
| Soluble Fiber | 12.6 | % |
| Moisture by Forced Air (1 hr) | 8.31 | % |
| Protein by Dumas (F = 5.70) | 11.2 | % |
| Starch, Total | 23.1 | % |

Study Demonstrating Modified Cereals for Cholesterol Reduction
A. Purpose of the Study

Diet therapy is the first line of treatment for those at risk for cardiovascular disease (CVD) due to high plasma levels of LDL cholesterol (LDL-C), alone, or with other risk factors. Replacing saturated fat with carbohydrate, monounsaturated, or polyunsaturated fat will reliably lower LDL-C levels in most individuals. Additional studies suggest that water soluble fibers (such as those found in oat bran) may lower LDL-C.

B. Participants

This study involved healthy males and females recruited from all races with slightly elevated LDL-C levels. The target of the program was to enroll a total of 26 individuals.

Participants were Required to Meet the Following Inclusion Criteria:
Male or female of any race or ethnicity between 20 to 70 years of age, inclusive;
Body mass index between 20-35 kg/m²;
LDL-cholesterol between 130-189 mg/dl based on the average of duplicate screening measures. If the two LDL-C levels differ by more than 30 mg/dl, a third test will be scheduled with all three results averaged;
Free of chronic disease;
Willing to eat only the foods that are provided by the Center during the diet periods;
Willing to abstain from the consumption of alcohol for 48-hours prior to blood draw days.

Participants were Excluded for any of the Following:
Age <20 or >70 years;
Based on duplicate screening laboratory values: 1) LDL-C≧190 mg/dl; 2) TG≧500 mg/dl; 3) blood pressure≧160 mm Hg systolic or 95 mm Hg diastolic;
Documented presence of atherosclerotic disease;
Diabetes mellitus;
Renal, hepatic, endocrine, gastrointestinal, hematological or other systemic disease;
Body mass index≧35;
For women, pregnancy, breast feeding or postpartum<6 months;
For women, peri-menopausal;
History of drug or alcohol abuse;
History of depression or mental illness requiring treatment or medication within the last 6 months;
Multiple food allergies or significant food preferences or restrictions that would interfere with diet adherence;
Chronic use of over-the-counter medication which would interfere with study endpoints including NSAIDS, laxatives and antacids;
Lifestyle or schedule incompatible with the study protocol;
Planned continued use of dietary supplements through the study trial.

The use of hormone replacement therapy and birth control pills were allowed. Women of child-bearing age were allowed to use approved birth control methods. Use of tobacco products also were allowed.

C. Recruitment

The program enrolled 26 individuals from a pool of eligible participants drawn from the greater Baton Rouge Community. Methods for recruitment included the use of print and radio advertisement, presentations on television and mailed brochures.

D. Participant Screening

Participant eligibility were assessed by a series of screenings to include one telephone screening interview and three clinic visits.
Telephone Screening Interview. Potential participants were informed of the nature of the study and the extent of the required commitment. The inquiring participant were interviewed and screened for major exclusions.
Clinic Visit 1. The first of two fasting lipid measurements were obtained. Medical history, height, weight and blood pressure were obtained. An initial assessment of participant eligibility was made.
Clinic Visit 2. The second of two fasting lipid measurements was obtained. A complete chemistry panel, CBC, and urinalysis were done. Eligibility status was confirmed; if a third lipid panel was required, this was scheduled.
Clinic Visit 3. Participants received a physical by the Medical Investigator. The Medical Investigator reviewed all laboratory values with the participant and explained in detail the significance of the lipid values. CVD risk assessment and therapeutic options were discussed with the participants by the Medical Investigator. Potential participants also received a tour of the clinical facilities and learned in more detail their daily routine while in the study.
   E. Test Products

Oat bran. Oat bran is a natural food product currently available for purchase to incorporate into foods such as baked goods and cereals. Consumption of oat bran as part of a healthy diet is known to significantly lower LDL-C. Because of this, a health claim has been granted for foods such as oat bran, which contain at least 0.75 grams of soluble fiber a day (¼ the minimum amount needed to provide significant cholesterol lowering—3 grams/day). At 2200 calories, the study provided sufficient oat bran to incorporate 5-6 grams of soluble fiber/day into the diet. The inclusion of an oat bran treatment protocol in the study served as both a positive control for the study and as a measurement against which the cholesterol-lowering properties of the other test products were evaluated.

Modified wheat bran. Wheat bran is a natural food product currently available for purchase to incorporate into foods such as baked goods and cereals. Natural wheat bran contains primarily insoluble fiber and as such has low, if any, cholesterol-lowering properties. To increase the potential for cholesterol-lowering, the test product was chemically modified through alkali treatment with calcium hydroxide (lime) to increase the solubility of the fiber. Alkali treatment with calcium hydroxide is a standard food processing procedure (known as nixtamalization) used on corn (to soften the often-tough outer skin) to produce masa for tortillas. It was not expected that the tolerability of the modified wheat bran would be different from that of either unmodified wheat bran or a fiber with a similar water-soluble fiber content. At 2200 calories, the study provided sufficient modified wheat bran to incorporate about 4.5 grams of soluble fiber/day into the diet.

F. Dietary Procedures

Four diets were provided to participants for four weeks each in a randomized cross-over design. Assuming completion of the entire protocol, each participant consumed each of the four diets.

Diet Run-In. Following successful screening, prospective participants who met the eligibility requirements participated in a four-day run-in period for calorie adjustment and to familiarize them with the requirements of the study and to allow those who felt that they could not tolerate the study's demands to drop out prior to randomization.

Randomization. Participants who successfully completed the Diet Run-in period and expressed continued interest in participating in the study were randomized to one of 24 possible diet sequences. Minimization techniques were used to provide balance assignments with respect to sex and LDL-C across the dietary sequences. The assigned dietary sequences were electronically returned to the study dietitian within 24 hrs.

Diet Composition Goals. Participants were fed an average American diet with a calculated macronutrient composition as indicated in Table 6.

TABLE 6

| Nutrients | AAD |
|---|---|
| Protein, % kcal | 15 |
| Carbohydrate, % kcal | 50 |
| Fat, % kcal | 35 |
| Saturated fat, % kcal | 14 |
| Monounsaturated fat, % kcal | 13 |
| Polyunsaturated fat, % kcal | 8 |
| Cholesterol, mg/d* | 300 |
| Fiber, g/d* | 9 |

*Target levels for a 2,200 kcal diet.

Four diets were prepared: three experimental diets containing various quantities of test products and one control diet (labeled AAD—average American diet) containing an equivalent amount of flour. Two test products and amounts were: 1) oat bran at 60 g/day at 2,200 kcals; and 2) modified wheat bran at 30 g/day at 2,200 kcals. Amounts of bran and soluble fiber contents for these diets are presented in Table 7. The test products were, to the extent possible, incorporated in baked goods. The amounts of test product will be factored up or down according to the calorie level of the base diet provided to each individual.

TABLE 7
FIBER CONTENTS OF DIETS

| | Calorie Level | | | | |
|---|---|---|---|---|---|
| | 1800 | 2200 | 2600 | 3000 | 3400 |
| Oat Bran, g | 52 | 63 | 75 | 86 | 97 |
| Soluble Fiber, g | 4.4 | 5.3 | 6.3 | 7.3 | 8.3 |
| Mod. Wheat Bran, g | 35 | 42 | 50 | 58 | 66 |
| Soluble Fiber, g | 4.4 | 5.3 | 6.3 | 7.3 | 8.3 |

Length and Timing of Diet Intervention. Participants were provided each diet, in random sequence, for four weeks each. For each of the four four-week diet periods, participants were provided complete diets meeting the appropriate nutrient specifications. Participants were provided with short breaks (about 1 week) between diet periods to provide relief from the demands of the protocol. The diet periods were planned so as not to interfere with major holidays such as Easter and Independence Day when problems with participant compliance might be anticipated.

Controlled Diets. The participants were provided with all foods for the duration of the study, and were encouraged to consume all foods provided. The participants were not told of their dietary group assignments. All personnel involved in determining outcome variables were blinded with respect to the test diets. A 5-day menu cycle was used. On weekdays, the participants were required to consume breakfast and dinner at the dining facility. Weekday lunches and snacks were packaged for take-out and were distributed at breakfast. Weekend meals were packaged and distributed at the Friday dinner.

The participants were begun on the energy level that most closely matched their estimated energy requirement according to the Schofield equation for RMR and an estimate of physical activity. Each study diet was prepared at five energy levels (1800, 2200, 2600, 3000, and 3400 kcal/day). “Unit” foods of cookies, breads, and muffins with about 100 kcals, meeting the nutrient specification of each diet, were provided for adjusting energy intake. Dietary energy adjustments were made as needed to maintain weight within 1 kg of their initial value. Participants were weighed each weekday.

Participants were also allowed a limited choice of seasonings and beverages within their assigned dietary treatment. Beverages containing caffeine were limited to less than 5 cups per day. Alcohol were not served at the test facility, but were allowed in moderation (no more than 2 per day). Participants were not allowed to take vitamin/mineral supplements. Participants recorded in a daily diary any deviations from the diet and the consumption of self-selected beverage items.

Menu Development. Menus were developed by the Metabolic Kitchen research dietitians, and analyzed using the ProNutra database. Recipes were selected to include regional food preferences to increase dietary adherence. After taste-testing, the food products were analyzed for nutrient content, and then included in the database for menu planning.

Diet Preparation. Food purchases were based on specifications outlined during menu development to meet nutrient content requirements. When possible, foods to be used throughout the research study were purchased at one time from a single lot to ensure minimum variation, and properly stored.

Standardized recipes outlining specific ingredients and gram weights, correct mixing and cooking procedures, timing, and use of equipment were meticulously followed under sanitary procedures. All ingredients were weighed to 0.1 gram on electronic balances. Mixed foods were prepared in batch quantities. Those foods were then individually portioned, weighed, sealed, labeled, and frozen until ready to use.

Diet Distribution. Daily food production sheets for each participant were used, listing day, menu cycle, meal, food items required with portion weights, and special dietary requirements. When preparing the meal trays, the food production sheets were followed. Additionally, foods were labeled with participant study ID numbers for participant identification. Foods were placed on individual meal trays until served, or individually packaged for take-out, following tray assembly forms. At the time of meal pick-up, the hostess were reviewed the menu with the participant, checking off the foods to confirm all were provided. Meals were served to the participant on test days only after all study procedures had been completed.

Each participant completed a Daily Food Diary to assist with compliance assessment. The participant was asked to record study foods not eaten, non-study foods eaten, beverages consumed, number of unit foods eaten, and other study-specific food consumption information. The dietetic coordinator reviewed the Daily Food Diaries and compiled a compliance score for each participant. Additionally, the dietetic research associates obtained daily comments from each participant, and recorded dietary progress notes. Potential problems with meal acceptance were identified and resolved. A weekly monitoring form was completed to note any illness, medication use (both prescription and over-the-counter), changes in smoking habits, changes in physical activity and menstrual cycle.

G. Endpoint Collections

Endpoint Assessments. All assessments were made in the morning prior to the breakfast meal and after a minimum 10-hour fast and 48-hour abstinence from alcohol. Assessments were made twice at the end of each diet period on non-consecutive days during week 4 of the diet.

Endpoints collected for this study included:
Total cholesterol
Triglycerides
High-density lipoprotein cholesterol
Low-density lipoprotein cholesterol (calculated)
Glucose
Insulin

An additional aliquot of serum were kept and archived for subsequent evaluation of leptin, vitamin E, β-carotene, and a chemistry panel.

Blood Collection and Processing. Venous blood was collected with minimal hemostasis with participants in a sitting position. Blood was collected in tubes containing 1.5 mg/ml EDTA for procedures requiring plasma and “red-top” tubes for procedures requiring serum. A total of 14 mls of blood was drawn on each endpoint collection day totaling 28 mls of blood at the end of each diet period (2 endpoint collections/diet period×14 mls/endpoint collection) and 112 mls of blood for the entire study period (4 diet periods×28 mls/diet period).

H. Data Management and Participant Privacy

Participants were assigned a unique facility ID number when they began the recruiting process. All participants enrolled in the study were assigned a study ID at the time of enrollment. A table was created in the central database to allow a cross reference between the facility ID number and the study ID number. This information was kept in electronic format in a secured SQL database and was not printed or retained on any paper documents. The SQL database was secured and accessible only by the individuals in the data management group by logon ID and password privilege. Study data collected was identified by the study ID number and maintained in a study specific database. Assigning a study ID to the participants and collecting all data and samples using this study identification number de-identified data and did not allow data or samples to be linked to a particular participant.

Following a participant's completion of the intervention, four weeks were allowed to resolve any issues requiring contact with the participants. After this four-week time period, the study investigators were not provided with any cross-reference information that may enable them to link a study identification with a study participant.

All data storage and transfer met all Federal privacy guidelines (HIPAA). Specifically, all medical records were stored in a locked area in the clinic. Access to this area and the individual charts was limited to clinical support staff, Director of the Clinical Facilities and the Principal Investigator. All hard copies of data sheets from protocols were stored in the medical record. Subject medical records were filed according to an assigned Study ID number. All forms on the chart, with the exception of the consent, displayed only the subject Study ID number.

I. Participant Safety

Data on changes in physical activity, illness, prescription and non-prescription medication use, and for women, menstrual cycle were obtained on a weekly basis through administered questionnaires.

A staff physician and research staff nurses screened the subject and, therefore, were directly involved in health assessment of the subject. All medical screening and laboratory results which were abnormal (pre and post-treatment) were reviewed by a Clinical Chemist (lab reports only) and forwarded to the Medical Investigator. In the instance of an adverse event, the IRB was immediately notified with concomitant notification of the Principal Investigator.

J. Participant Feedback

Following completion of their involvement in the study, participants were provided a letter detailing their screening lipid values and their values on each of the four diets. The letter also included current guidelines for treatment based on risk factor levels and explicitly stated whether the participant's risk factor level preliminarily qualifies them for some level of intervention (diet and/or drug). If intervention was suggested, the participant was encouraged to discuss the findings with his or her personal physician.

K. Power Calculation and Study Size

This study was designed to detect a 6% change in LDL-C with 85% power. Sample size calculations were based on variance estimates obtained from the multi-center DELTA study and reasonably approximated the variances expected in the present study. Assuming an average LDL-C of 130 mg/dl, a 6% change equates to 7.8 mg/dl. Without corrections for multiple statistical comparisons, it was estimated to have 85% power to detect a 6% difference in LDL-C at α=0.05 with 20 participants completing all four diet periods. To accommodate a drop-out rate of approximately 25%, the study targeted enrolling 26 participants. Statistical power values are shown further in Table 8.

TABLE 8
STATISTICAL POWER

| | | | Minimal Detectable | | | | Minimal Detectable | | | |
|---|---|---|---|---|---|---|---|---|---|---|
| | Variances | | Differences | | | | Differences | | | |
| | Within | Diet × | α = 0.05 and 85% Power | | | | α = 0.013 and 85% Power | | | |
| Endpoint | Subject | Subject | N = 16 | N = 20 | N = 24 | N = 26 | N = 16 | N = 20 | N = 24 | N = 26 |
| Total cholesterol; mg/dl | 98.9 | 44.7 | 10.3 | 9.2 | 8.4 | 8.1 | 11.8 | 10.6 | 9.6 | 9.3 |
| LDL cholesterol; mg/dl | 80.0 | 27.5 | 8.7 | 7.8 | 7.1 | 6.8 | 10.0 | 8.9 | 8.2 | 7.8 |
| HDL cholesterol; mg/dl | 9.6 | 7.9 | 3.8 | 3.4 | 3.1 | 3.0 | 4.3 | 3.9 | 3.5 | 3.4 |
| Triglycerides; mg/dl | 275 | 77 | 15.5 | 13.9 | 12.7 | 12.2 | 17.8 | 15.9 | 14.5 | 14.0 |

A published meta-analysis for oat bran consumption by Brown et al (AJCN, 69:30-42, 1999) predicts a 1.43 mg/dl reduction in LDL-C per gram of oat bran soluble fiber. Based on an intake of 60 grams of oat bran providing 5.34 grams of soluble fiber, a reduction in LDL-C of 7.6 mg/dl was predicted. The study, as designed, was predicted to statistically (p=0.05) detect this difference with oat bran with 80% probability. This difference was indeed identified in the following results.

G. Participant Progress

A total of 35 participants, 14 males and 21 females, completed the screening process and received randomizes diet protocols. Of these participants, 27 (12 males and 15 females) completed the first diet period, 23 (11 males and 12 females) completed the second diet period, 22 (10 males and 12 females) completed the third diet period, and 21 (10 males and 11 females) completed the fourth diet period. Of the 21 participants that completed the four diet periods, 20 participants (10 males and 10 females) were evaluative with respect to determination of final blood levels of selected compounds.

The characteristics of the final participants with respect to their medical condition at the start of the study are summarized in Table 9.

TABLE 9
PARTICIPANT CHARACTERISTICS

| | Ave ± SD | Range |
|---|---|---|
| Age, y | 52 ± 11 | 32-66 |
| BMI, kg/m² | 27.4 ± 4.3 | 20.8-34.7 |
| Total Cholesterol, mg/dl | 232 ± 19 | 198-263 |
| LDL Cholesterol, mg/dl | 150 ± 14 | 130-177 |
| HDL Cholesterol, mg/dl | 55 ± 10 | 39-71 |
| Triglycerides, mg/dl | 134 ± 46 | 63-277 |
| Glucose, md/dl | 99 ± 9 | 85-121 |
| Systolic BP, mmHg | 116 ± 12 | 96-136 |
| Diastolic BP, mmHg | 75 ± 10 | 54-88 |

H. Results

The primary result of the study are summarized in Table 10.

TABLE 10
PRIMARY RESULTS

| | ADD | OB | MWB |
|---|---|---|---|
| TC, mg/dl | 227 ± 32 | 215 ± 25* | 219 ± 28** |
| LDL-2C, mg/dl | 147 ± 24 | 137 ± 18** | 137 ± 20** |
| HDL-C, mg/dl | 52.0 ± 9.3 | 52.9 ± 9.0 | 51.7 ± 9.9 |
| Trig, mg/dl | 143 ± 49 | 131 ± 50 | 154 ± 56⁺ |
| Ln(TG) | 4.90 ± 0.36 | 4.81 ± 0.37 | 4.98 ± 0.35⁺ |
| Gluc, mg/dl | 96 ± 11 | 95 ± 9 | 97 ± 12 |
| Insulin, uU/ml | 10.7 ± 6.8 | 9.1 ± 6.1** | 10 ± 6.0 |

*Significantly different from AAD (P < 0.05)
**Significantly different from AAD (P < 0.01
⁺Significantly different from OB (P < 0.001)
mg/dl = milligram per deciliter of blood
uU = insulin units
Ln(TG) is the natural log of TG in mg/dl

As expected, oat bran in the planned diet significantly lowered LDL-Cholesterol without affecting HDL-cholesterol resulting in a lower total cholesterol level. On a soluble fiber basis, modified wheat bran was as effective as oat bran in reducing LDL-cholesterol. Oat bran tended to lower triglycerides, while modified wheat bran tended to raise triglycerides. Oat bran, but not wheat bran lowered insulin levels.

Safety data based on further analysis of the blood samples is reported in Table 11.

TABLE 11
SAFETY DATA

| | ADD | OB | MWB |
|---|---|---|---|
| Albumin (g %) | 3.74 | 3.82 | 3.87** |
| Alkaline Phosphatase, | 72.5 | 70.1 | 68.1 |
| IU/L | | | |
| Alanine Aminotransam., | 20.1 | 19.4 | 19.7 |
| IU/L | | | |
| Creat. Phosphokinase, | 137 | 102 | 100 |
| IU | | | |
| Creatinine, mg/dL | 0.84 | 0.93 | 0.95 |
| Uric Acid, mg/dL | 5.40 | 5.55 | 5.46 |
| Calcium, mg/dL | 9.43 | 9.42 | 9.46 |
| Potassium, mmol/L | 4.38 | 4.44 | 4.41 |
| Magnesium, mg/dL | 2.12 | 2.16 | 2.17 |
| Iron, ug/dL | 87.9 | 95.4 | 92.2 |

*Significantly different from AAD (P < 0.05)

These results confirm that no abnormal blood chemistry was observed from the diets.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What we claim is:

1. A method for the reduction of serum cholesterol in a mammal, the method comprising consuming a grain product having an enhanced soluble fiber content due to hydrolysis of insoluble fibers in the grain product.

2. The method of claim 1 wherein the mammal is a human.

3. The method of claim 1 wherein the mammal is a pet.

4. The method of claim 1 wherein the grain product comprises hydrolized wheat bran.

5. The method of claim 1 wherein the grain product comprises oat bran, corn bran or rice bran.

6. The method of claim 1 wherein hydrolysis of the grain product comprises cooking the grain product following the addition of an alkali composition to the grain product.

7. The method of claim 6 wherein the alkali composition comprises calcium oxide, calcium hydroxide or a combination thereof.

8. The method of claim 1 wherein the consuming of the grain product comprises ingesting sufficient grain to reduce serum cholesterol levels at a statistically significant amount.

9. The method of claim 1 wherein the consuming of the grain product comprises ingesting from about 20.0 grams to about 150 grams per day.

10. The method of claim 1 wherein the ingesting of the modified grain product comprises consuming a breakfast cereal.

11. The method of claim 10 wherein the ingesting of the modified grain product comprises consuming a baked product formulated with the modified grain product.

12. The method of claim 1 further comprising measuring the cholesterol level of the mammal to establish a target cholesterol reduction.

13. A method for increasing bile binding ability of a grain composition, the method comprising hydrolyzing the insoluble fiber of a grain product to increase the soluble fiber content.

14. The method of claim 13 wherein the hydrolyzed grain product has no more than about 500 ppm total lysinoalanine.

15. A breakfast cereal comprising a grain composition with a hydrolyzed grain product having an increased soluble fiber content relative to an equivalent un-hydrolyzed grain product.

16. The breakfast cereal of claim 15 wherein the grain composition comprises wheat bran.

17. The breakfast cereal of claim 15 wherein the hydrolyzed grain product has no more than about 500 ppm total lysinoalanine.

18. The grain product of claim 15 having at least about 8% by weight soluble fiber.

19. The grain product of claim 15 having a ratio of soluble fiber to dietary fiber of at least about 1:10.

20. A bran flour comprising a hydrolyzed grain product having an increased soluble fiber content relative to an equivalent un-hydrolyzed grain product.
